(19) United States
(12) Patent Application Publication
(10) Pub. No.: US 2009/0161268 A1
(43) Pub. Date: Jun. 25, 2009

(54) CURRENT-PERPENDICULAR-TO-PLANE READ SENSOR WITH AMORPHOUS FERROMAGNETIC AND POLYCRYSTALLINE NONMAGNETIC SEED LAYERS

(76) Inventor: Tsann Lin, Saratoga, CA (US)

Correspondence Address: PATTERSON & SHERIDAN, L.L.P., 3040 POST OAK BLVD., SUITE 1500, HOUSTON, TX, 77056, US

(21) Appl. No.: 11/963,803

(22) Filed: Dec. 22, 2007

(51) Int. Cl. G11B 5/33; B29C 65/00; G11B 5/39

(52) U.S. Cl. 360/324.11; 156/182; 428/811.3

(57) ABSTRACT

A method, apparatus, and article of manufacture for a current-perpendicular-to-plane (CPP) giant magnetoresistance (GMR) or a tunneling magnetoresistance (TMR) read sensor is proposed. The CPP read sensor comprises an amorphous ferromagnetic first seed layer, a polycrystalline nonmagnetic second seed layer, a nonmagnetic first cap layer, a nonmagnetic second cap layer, and a ferromagnetic third gap layer. A read gap is defined by a distance between the ferromagnetic first seed layer and the ferromagnetic third cap layer.

### BACKGROUND OF THE INVENTION

1. Field of the Invention

Embodiments of the present invention generally relate to read sensors.

2. Description of the Related Art

A current-in-plane (CIP) giant magnetoresistance (GMR) read sensor has been commonly used for magnetic recording in a storage system. The CIP GMR read sensor is electrically connected with longitudinal bias layers and conducting leads in two side regions. This structure allows a sense current to flow in a direction parallel to the sensor plane. The longitudinal bias layers and conducting leads are electrically separated by lower and upper gap layers from lower and upper shields, respectively, for preventing the sense current from shunting into the lower and upper shields. Shunting occurring when an electric current passes through an unintended path will cause the CIP GMR read sensor to malfunction.

To achieve longitudinal bias stabilization through magnetostatic interactions between the CIP GMR read sensor and the longitudinal bias layers, the CIP GMR read sensor is patterned in a photolithographic process to produce tapers at its edges for abutting with the longitudinal bias layers. However, resulting abutting junctions may cause unwanted side reading, thus producing a magnetic read track wider than a physical read track defined by photolithographic patterning. Further, to seal the CIP GMR read sensor completely, the lower and upper gap layers must be thick enough to cover topographies of the lower shield and CIP GMR read sensor, respectively, without pinholes. A resulting read gap, defined as a distance between the lower and upper shields (i.e., the total thickness of the CIP GMR read sensor, the lower and upper gap layers), is thus too thick to confine magnetic fluxes stemming from a recording medium for a high linear resolution in magnetic recording.

Another type of read sensor is a current-perpendicular-to-plane (CPP) GMR or tunneling magnetoresistance (TMR) read sensor. In contrast to the CIP GMR read sensor, the CPP GMR or TMR read sensor is electrically separated by side oxide layers from longitudinal bias layers in two side regions for preventing a sense current from shunting into the two side regions, but is electrically connected with lower and upper shields for the sense current to flow in a direction perpendicular to the sensor plane. The CPP GMR or TMR read sensor is patterned in a photolithographic process to produce sharp edges, so that a smaller magnetic read width can be very well defined by the side oxide layers. Further, a read gap, defined by a distance between the lower and upper shields (i.e., the thickness of the CPP GMR or TMR read sensor itself) is so thin that a much higher linear density can be achieved.

### SUMMARY OF THE INVENTION

The present invention is generally directed to a method, apparatus, and article of manufacture for a current-perpendicular-to-plane (CPP) giant magnetoresistance (GMR) or a tunneling magnetoresistance (TMR) read sensor.

One embodiment provides an apparatus of a current-perpendicular-to-plane read sensor. The CPP read sensor comprises a lower sensor stack, an upper sensor stack, and an intermediate layer disposed between the lower and upper sensor stacks. The lower sensor stack comprises a first seed layer formed by an amorphous ferromagnetic film, a second seed layer formed by a polycrystalline nonmagnetic film deposited on the first seed layer, a pinning layer deposited on the second seed layer, a keeper layer deposited on the pinning layer, an antiparallel-coupling layer deposited on the keeper layer, and a reference layer deposited on the antiparallel-coupling layer. The upper sensor stack comprises sense layers deposited on the intermediate layer, a first nonmagnetic cap layer deposited on the sense layers, a second nonmagnetic cap layer deposited on the first cap layer, and a third ferromagnetic third cap layer deposited on the second cap layer.

Another embodiment provides a read head comprising a lower shield, a current-perpendicular-to-plane (CPP) read sensor and an upper shield. The CPP read sensor comprises a lower sensor stack, an upper sensor stack and an intermediate layer disposed between the lower and upper sensor stacks. The lower sensor stack comprises a first seed layer formed by an amorphous ferromagnetic film deposited on the lower shield, a second seed layer formed by a polycrystalline nonmagnetic film deposited on the first seed layer, a pinning layer deposited on the second seed layer, a keeper layer deposited on the pinning layer, an antiparallel-coupling layer deposited on the keeper layer, and a reference layer deposited on the antiparallel-coupling layer. The upper sensor stack comprises sense layers deposited on the intermediate layer, a first nonmagnetic cap layer deposited on the sense layers, a second nonmagnetic cap layer deposited on the first cap layer, and a third ferromagnetic third cap layer deposited on the second cap layer.

Another embodiment provides a hard disk drive comprising a hard disk, an actuator arm, a slider disposed upon a distal end of the actual arm and positionable over the hard disk, a read head disposed on the slider, and a write head fabricated on the read head. The read head includes a lower shield, a CPP read sensor, an upper shield, two oxide layers at two side regions of the CPP read sensor, and two longitudinal bias layers deposited on the two oxide layers. The CPP read sensor comprises a lower sensor stack, an upper sensor stack, and an intermediate layer disposed between the lower and upper sensor stacks. The lower sensor stack comprises a first seed layer formed by an amorphous ferromagnetic film deposited on the lower shield, a second seed layer formed by a polycrystalline nonmagnetic film deposited on the first seed layer, a pinning layer deposited on the second seed layer, a keeper layer deposited on the pinning layer, an antiparallel-coupling layer deposited on the keeper layer, and a reference layer deposited on the antiparallel-coupling layer. The upper sensor stack comprises sense layers deposited on the intermediate layer, a first nonmagnetic cap layer deposited on the sense layers, a second nonmagnetic cap layer deposited on the first cap layer, and a third ferromagnetic third cap layer deposited on the second cap layer.

Still another embodiment provides a method for fabricating a current-perpendicular-to-plane (CPP) read sensor. The method comprises depositing a first seed layer formed by an amorphous ferromagnetic film on a lower shield, depositing a second seed layer formed by a polycrystalline nonmagnetic film on the first seed layer, depositing a pinning layer on the second seed layer, depositing a keeper layer on the pinning layer, depositing an antiparallel-coupling layer on the keeper layer, depositing a reference layer on the antiparallel-coupling layer, depositing an intermediate layer on the reference layer, depositing sense layers on the intermediate layer, and depositing a capping structure on the sense layers.

Yet another embodiment provides an article of manufacture, comprising a first seed layer formed by an amorphous ferromagnetic film, a second seed layer formed by a polycrystalline nonmagnetic film, a first cap layer formed by a nonmagnetic film, a second cap layer formed by a nonmagnetic film, and a third cap layer formed by a ferromagnetic film. The first seed layer, second seed layer, the first cap layer, the second cap layer, and the third cap layer are components of a current-perpendicular-to-plane read sensor. Since a read gap is defined by a distance between ferromagnetic films beneath and above the read sensor, it is thus reduced from that between the lower and upper ferromagnetic shields to that between the ferromagnetic first seed and third cap layers.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of the invention and are therefore not to be considered limiting of its scope, for the invention may admit to other equally effective embodiments.

FIG. 1 is a block diagram depicting a hard disk drive according to one embodiment of the invention.

FIG. 2 is a block diagram depicting exemplary layers included in a current-perpendicular-to-plane tunneling magnetoresistance read sensor according to one embodiment of the invention.

FIG. 3 is a graph depicting x-ray diffraction patterns taken from as-deposited 18.2 nm thick 86.6% Co-13.4% Fe and 22 nm thick 73.4% Co-10.9% Fe-15.7% Hf films according to one embodiment of the invention.

FIG. 4 is a graph depicting easy-axis and hard-axis hysteresis loops of 18.2 nm thick 86.6% Co-13.4% Fe and 22 nm thick 73.4% Co-10.9% Fe-15.7% Hf films, which are coated by a 3 nm thick Ta overcoat and annealed for 5 hours at 240° C., according to one embodiment of the invention.

FIG. 5 is a graph depicting easy-axis magnetic responses of Ir—Mn (6 nm)/Co—Fe (3.6 nm)/Ta (3 nm) films with various seed layers according to one embodiment of the invention.

FIG. 6 is a graph depicting the unidirectional anisotropy field (H_{UA}) versus the temperature for Ir—Mn (6 nm)/Co—Fe (3.6 nm)/Ta (3 nm) films with various seed layers according to one embodiment of the invention.

FIG. 7 is a graph depicting the interfacial exchange-coupling energy (J_{K}) versus the seed-layer thickness (δ_{Seed}) for Ir—Mn (6 nm)/Co—Fe (3.6 nm)/Ta (3 nm) layers with various seed layers according to one embodiment of the invention.

FIGS. 8 and 9 are graphs depicting the ferromagnetic coupling field (H_{F}) and the tunneling magnetoresistive (TMR) coefficient (ΔR_{T}/R_{J}), respectively, versus the resistance-area product (R_{J}A_{J}) for the TMR sensors according to one embodiment of the invention.

### DETAILED DESCRIPTION

In the following, reference is made to embodiments of the present invention. However, it should be understood that the invention is not limited to specifically described embodiments. Instead, any combination of the following features and elements, whether related to different embodiments or not, is contemplated to implement and practice the invention. Furthermore, in various embodiments the invention provides numerous advantages over the prior art. However, although embodiments of the invention may achieve advantages over other possible solutions and/or over the prior art, whether or not a particular advantage is achieved by a given embodiment is not limiting of the invention. Thus, the following aspects, features, embodiments and advantages are merely illustrative and, unless explicitly present, are not considered elements or limitations of the appended claims.

Embodiments of the present invention provide a method and apparatus for a CPP GMR or TMR sensor with amorphous ferromagnetic and polycrystalline nonmagnetic seed layers, as well as nonmagnetic and ferromagnetic cap layers. The CPP GMR or TMR read sensor exhibits a very small read gap, which is defined by a distance between the ferromagnetic seed and cap layers. In a particular embodiment, a read sensor of the present invention may perform magnetic recording at relatively high linear densities.

In one embodiment of the invention, an amorphous ferromagnetic seed layer deposited over a lower polycrystalline ferromagnetic shield acts as part of the lower shield and provides a flat surface for a polycrystalline nonmagnetic seed layer to grow freely with its own preferred crystalline texture. In one embodiment, the amorphous ferromagnetic seed layer is composed of Co—Fe—X, where X is selected from hafnium (Hf), zirconium (Zr), yttrium (Y) and boron (B).

In one embodiment of the invention, the polycrystalline nonmagnetic seed layer preferably exhibits a face-centered-cubic (fcc) or hexagonal-centered-cubic (hcp) structure. These cubic structures facilitate overlying layers of the read sensor to grow with a preferred crystalline structure. A preferred crystalline structure exhibits high pinning fields and good GMR or TMR properties. In one embodiment, the polycrystalline nonmagnetic seed layer is sputtered at a target power of as high as 600 watts (W) for achieving high atomic mobility needed to form a flat surface.

In one embodiment of the invention, the nonmagnetic first and second cap layers may be made of ruthenium (Ru) and tantalum (Ta) films, respectively. The nonmagnetic first and second cap layers may be sputtered at a target power of as low as 200 W for achieving low atomic mobility needed to avoid interface mixing with the underlying sense layers.

In one embodiment of the invention, the ferromagnetic third cap layers is made of a Ni—Fe film, which may protect the CPP GMR or TMR sensor from being damaged during chemical-mechanical polishing (CMP). The ferromagnetic third cap layer may also act as part of the upper ferromagnetic shield.

In one embodiment of the invention, an amorphous ferromagnetic first seed layer and a polycrystalline nonmagnetic second seed layer form a portion of a read sensor used in a disk drive. This read sensor is manufactured by depositing the amorphous ferromagnetic first seed layer on a substrate, then depositing the polycrystalline nonmagnetic second seed layer on the amorphous ferromagnetic first seed layer. The polycrystalline nonmagnetic second seed layer exhibits a cubic structure with a freely developed preferred crystalline texture. As a result, all layers subsequently grown on these seed layers will also have preferred structures with preferred crystalline texture, leading to increased pinning fields and improved GMR or TMR properties.

To facilitate understanding, a compound is expressed in the following format: a at % X-b at % Y-c at % Z (δ nm), and the explanation of this notation is provided below. This notation indicates that the compound comprises three chemical elements X, Y and Z with contents of a, b, c atomic %, respectively, and has a thicknesses of δ in nanometer (nm). For example, the notation of 73.4 at % Co-10.9 at % Fe-15.7 at % Hf (22 nm) indicates that the compound comprises three chemical elements cobalt, iron and hafnium with contents of 73.4, 10.9 and 15.7 atomic %, respectively, and has a thicknesses of 22 nanometer. In addition, this notation can be simplified as 73.4% Co-10.9% Fe-15.7% Hf (22 nm).

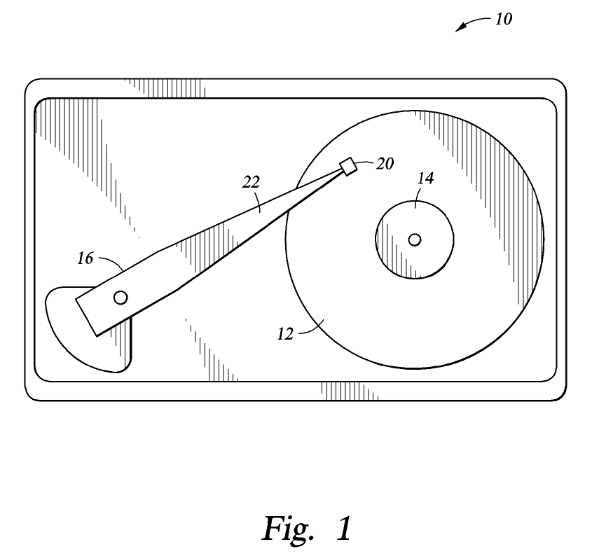

FIG. 1 is a block diagram depicting a hard drive 100 according to one embodiment of the invention. The hard disk drive 100 includes a hard disk 112 mounted upon a motorized spindle 114. An actuator arm 116 is pivotally mounted within the hard disk drive 100 with a slider 120 disposed upon a distal end 122 of the actuator arm 116. During operation of the hard disk drive 100, the hard disk 112 rotates upon the spindle 114 and the slider 120 acts as an air bearing surface (ABS) adapted for flying above the surface of the hard disk 112. The slider 120 includes a substrate base upon which various layers and structures that form a magnetic read/write head are fabricated. Magnetic read/write heads disclosed herein can be fabricated in large quantities upon a substrate and subsequently sliced into discrete magnetic read/write heads for use in devices such as the hard disk drive 100. The read head includes a CPP GMR or TMR read sensor that performs a read process in magnetic recording. In one embodiment of the invention, the TMR read sensor included in the read head comprises amorphous ferromagnetic and polycrystalline nonmagnetic seed layers. The amorphous ferromagnetic and polycrystalline nonmagnetic seed layers, as described herein, facilitate the TMR read sensor to exhibit good read performance in the hard disk drive 100.

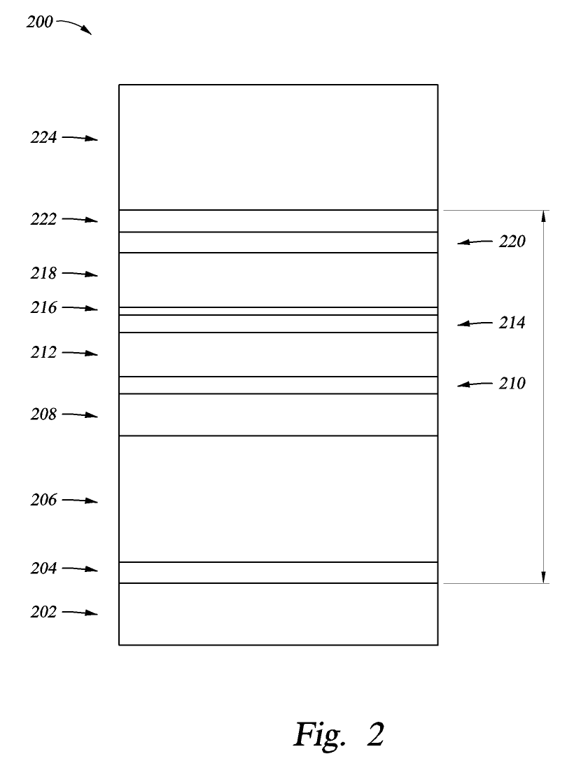

FIG. 2 is a block diagram depicting an exemplary CPP GMR or TMR read sensor 200. In one embodiment of the invention, a CPP GMR sensor is used, which comprises an electrically conducting spacer layer comprising a nonmagnetic copper (Cu) or oxygen-doped (Cu—O) film having a thickness ranging from 1.6 to 4 nm. When a sense current flows across the Cu of Cu—O spacer layer, a GMR effect is detected. In one embodiment, the intermediate layer 214 is a barrier layer. In another embodiment of the invention, a CPP TMR sensor is used, which comprises an electrically insulating barrier layer 214 comprising a nonmagnetic oxygen-doped magnesium (Mg—O) or oxidized magnesium (MgOx) film having a thickness ranging from 0.4 to 1 nm. When a sense current “quantum-jumps” across the Mg—O or MgO_{X} barrier layer, a TMR effect is detected.

The TMR read sensor 200 includes a lower sensor stack below the barrier layer 214. In one embodiment of the invention, the lower sensor stack comprises a first seed layer 202, a second seed 204, a pinning layer 206, a keeper layer 208, an antiparallel-coupling layer 210, and a reference layer 212. In one embodiment, the first seed layer 202 is amorphous and ferromagnetic, and thus also acts as part of the lower ferromagnetic shield. In one embodiment, the first seed layer 202 comprises cobalt (Co) with a content ranging from 60 to 80 at %, iron (Fe) with a content ranging from 0 to 40 at %, and X with a content ranging from 6 to 30 at %, where X is selected from hafnium (Hf), zirconium (Zr), yttrium (Y), and boron (B). The thickness of the first seed layer 202, which is irrelevant to the read gap (represented by the horizontal, bidirectional arrow), may range from 1 to 30 nm. In a particular embodiment of the invention, the first seed layer 202 is formed by a 3 nm thick amorphous ferromagnetic 73.4 at % Co-10.9 at % Fe-15.7 at % Hf film.

In one embodiment, the second seed layer 204 is disposed on the first seed layer 202. The second seed layer 204 may contain platinum (Pt) or rhodium (Rh) with a face-centered-cubic (fcc) structure, or a ruthenium (Ru) with a hexagonal-centered-cubic (hcp) structure. The thickness of the second seed layer 204 is relevant to the read gap and must be sufficiently small to minimize the read gap. In one embodiment, the second seed layer 204 thickness ranges from 1 to 2 nm. In a particular embodiment of the invention, the second seed layer 204 is formed by a 1 nm thick polycrystalline nonmagnetic Pt film.

In one embodiment, the pinning layer 206 is disposed on the second seed layer 204. In one embodiment, the pinning layer 206 comprises iridium (Ir) with a content ranging from 20 to 30 at %, manganese (Mn) with a content ranging from 70 to 80 at %, and chromium (Cr) with a content ranging from 2 to 6 at %. To exhibit strong antiferromagnatism, the thickness of the pinning layer 206 should be larger than a critical thickness of 4 nm. In one embodiment, the thickness of the pinning layer 204 ranges from 4 to 10 nm. In a particular embodiment of the invention, the pinning layer 206 is formed by a 6 nm thick antiferromagnetic 23.2 at % Ir-73.2 at % Mn-3.6 at % Cr film.

In one embodiment, the keeper layer 208 is disposed on the pinning layer 206. In one embodiment, the keeper layer 208 is ferromagnetic and comprises cobalt (Co) with a content ranging from 70 to 80 at % and iron (Fe) with a content ranging from 20 to 30 at %. The thickness of the keeper layer 208 should be small for exhibiting a high unidirectional anisotropy field (H_{UA}) when exchange-coupling to the underlying pinning layer 206. In one embodiment, the thickness of the keeper layer 208 from 3 to 5 nm. In a particular embodiment of the invention, the keeper layer 208 is formed by a 2.1 nm thick ferromagnetic 77.5 at % Co-22.5 at % Fe film.

In one embodiment, the nonmagnetic antiparallel-coupling layer 210 is disposed on the keeper layer 208. In one embodiment, the nonmagnetic antiparallel-coupling layer 210 comprises a nonmagnetic ruthenium (Ru), rhodium (Rh), iridium (Ir) or chromium (Cr) film. The thickness of the nonmagnetic antiparallel-coupling layer 210 should be small for exhibiting strong antiparallel-coupling. In one embodiment, the thickness of the nonmagnetic antiparallel-coupling layer 210 ranges from 0.4 to 2 nm. In a particular embodiment of the invention, the antiparallel-coupling layer 210 is formed by a 0.8 nm thick nonmagnetic Ru film.

Finally, in one embodiment, the reference layer 212 is disposed on the nonmagnetic antiparallel-coupling layer 210. In one embodiment, the reference layer 212 comprises cobalt (Co) with a content ranging from 40 to 60 at %, iron (Fe) with a content ranging from 30 to 40 at %, and boron (B) with a content ranging from 10 to 30 at %. The thickness of the reference layer 212 should be small for exhibiting a high antiparallel-coupling field (H_{APC}). In one embodiment, the thickness of the reference layer 212 ranges from 3 to 5 nm. In a particular embodiment of the invention, the reference layer 212 is formed by a 2 nm thick ferromagnetic 53 at % Co-33 at % Fe-14 at % B film.

In this lower sensor stack, the keeper layer 208, the antiparallel-coupling layer 210, and the reference layer 212 form a flux-closure structure. In addition to strong exchange-coupling between the pinning layer 206 and the keeper layer 208, strong antiparallel coupling occurs across the antiparallel-coupling layer 210. As a result, while the magnetization of the keeper layer 208 is rigidly pinned in a direction perpendicular to and away from the air-bearing surface (ABS), the magnetization of the reference layer 212 is rigidly pinned in a direction perpendicular to and towards the ABS. By minimizing the net magnetization in this flux-closure structure for reducing demagnetizing fields, the TMR read sensor can optimally operate.

The TMR read sensor 200 also includes an upper sensor stack above the barrier layer 214. In one embodiment of the invention, the upper sensor stack comprises a first sense layer 216, a second sense layer 218, a first cap layer 220, a second cap layer 222, and a third cap layer 224. In one embodiment, the first sense layer 216 is disposed on the barrier layer 214. The first sense layer 216 acts as a buffer layer for preventing the second sense layer 218 from contacting the barrier layer 214 and thus eliminating interfacial segregation. In one embodiment, the first sense layer 216 comprises cobalt (Co) with a content ranging from 80 to 90 at %, and iron (Fe) with a content ranging from 10 to 20 at %. The thickness of the first sense layer 216 should be thin enough to just cover the barrier layer 214. In one embodiment, the thickness of the first sense layer 216 ranges from 0.2 to 0.8 nm. In a particular embodiment of the invention, the first sense layer 208 is formed by a 0.4 nm thick ferromagnetic 87.1 at % Co-12.9 at % Fe film.

In one embodiment, the second sense layer 218 is disposed on the first sense layer 216. The second sense layer 218 may act as a key layer in maximizing TMR effects. In one embodiment, the second sense layer 218 comprises cobalt (Co) with a content ranging from 60 to 80 at %, iron (Fe) with a content ranging from 10 to 20 at %, and boron (B) with a content ranging from 4 to 30 at %. The thickness of the second sense layer 218 should be determined by a designed magnetic moment. In one embodiment, the thickness of the second sense layer 218 ranges from 2 to 6 nm. In a particular embodiment of the invention, the second sense layer 208 is formed by a 2.6 nm thick ferromagnetic 71.5 at % Co-7.4 at % Fe-21.1 at % B film.

In one embodiment, the first cap layer 220 is disposed on the second sense layer 218. The first cap layer 220 acts as a protection layer for preventing the second sense layer 218 from interfacial mixing and thus maintaining good ferromagnetic properties such as a low saturation magnetostriction (λ_{S}). In one embodiment, the first cap layer 220 comprises platinum (Pt), rhodium (Rh) or ruthenium (Ru). The thickness of the first cap layer should be thin enough to just cover the second sense layer 218. In one embodiment, the thickness of the first cap layer 220 ranges from 0.6 to 2 nm. In a particular embodiment of the invention, the first cap 220 is formed by a 1 nm thick nonmagnetic Ru film.

In one embodiment, the second cap layer 222 is disposed on the first cap layer 220. The second cap layer 222 may act as a decoupling layer for preventing the first sense layer 216 and the second sense layer 218 from exchange-coupling to the third cap layer 224. In one embodiment, the second cap layer 222 comprises a nonmagnetic tantalum (Ta), hafnium (Hf), zirconium (Zr) or yttrium (Y) film. The thickness of the second cap layer 222 should be thin enough to just cause the above mentioned decoupling. In one embodiment, the thickness of the second cap layer 222 ranges from 0.6 to 2 nm. In a particular embodiment of the invention, the second cap 220 is formed by a 1 nm thick nonmagnetic Ta film.

In one embodiment, the third cap layer 224 is disposed on the second cap layer 222. The third cap layer 224 may act as part of the upper ferromagnetic shield. In one embodiment, the third cap layer 224 comprises nickel (Ni) with a content ranging from 80 to 90 at %, and iron (Fe) with a content ranging from 10 to 20 at %. The thickness of the third cap layer 224 should be large enough to protect the TMR read sensor during processing. In one embodiment, the thickness of the third cap layer 224 ranges from 10 to 30 nm. In a particular embodiment of the invention, the third cap layer 224 is formed by a 10 nm thick ferromagnetic 82 at % Ni-18 at % Fe film.

In one embodiment, the first seed layer 202 and the third cap layer 224 act as parts of the lower and upper ferromagnetic shields, respectively. In other words, the lower ferromagnetic shield according to this embodiment comprises the about 1 μm thick Ni—Fe film and the first seed layer 202, while the upper ferromagnetic shield according to this embodiment comprises the third cap layer 224 and the other about 1 μm thick Ni—Fe film. In a particular embodiment of the invention, the read gap of this TMR read sensor substantially decreases from 28.5 to 17.7 nm. Due to this decrease in the read gap, it is expected that the use of this TMR read sensor can perform magnetic recording at a higher linear density.

A read head including the TMR sensor in accordance with one embodiment of the invention is fabricated as described below. The read head fabrication process begins with an 80 nm thick Ni—Fe seed layer being sputtered on a wafer. A lower shield frame is formed with photolithographic patterning, and a 1.2 μm thick Ni—Fe film is then electroplated into the lower shield frame. After removing the photoresist and the Ni—Fe seed layer outside of the lower shield frame, a 1.2 μm thick alumina (Al₂O₃) undercoat is deposited. The wafer is then planarized with chemical-mechanical-polishing (CMP), until the Ni—Fe film is exposed and its thickness is reduced to 1 μm. The lower shield embedded in the Al₂O₃ undercoat is thus formed, providing a smooth surface for the TMR sensor to grow.

After this first planarization process, the TMR read sensor in accordance with one embodiment of the invention is deposited on the wafer and annealed for 5 hours at 240° C. in a magnetic field of 50 kOe in a vacuum oven. Then, a 10 nm thick carbon protection layer is deposited on top of the TMR read sensor. A photoresist is applied to cover a longitudinal sensor stripe region with photolithographic patterning. The carbon protection layer and the TMR read sensor surrounding the photoresist are removed with reactive-ion-etching (RIE) and ion milling, respectively, and thus the TMR read sensor remains only within the longitudinal sensor stripe region. A 600 nm thick Al₂O₃ back filler is then deposited. After removing the photoresist, the TMR read sensor and surrounding Al₂O₃ back filler are planarized with CMP.

After this second planarization process, a transverse sensor stripe region is formed with photolithographic patterning, and the carbon protection layer and TMR read sensor adjacent to the photoresist are removed with RIE and with ion milling, respectively. A 4 nm thick Al₂O₃ lower side oxide layer, Cr (3)/Co—Pt—Cr (20) longitudinal bias layer, and a 10 nm thick Al₂O₃ upper side oxide layer are then sequentially deposited into two side regions adjacent to the transverse sensor stripe region. After removing the photoresist, the carbon protection layer on top of the TMR read sensor and surrounding Al₂O₃ upper side oxide layers are planarized with CMP.

After this third planarization process, the carbon protection layer on top of the TMR read sensor is removed with RIE, and the surface of the TMR sensor is cleaned with sputter etching. Then, an 80 nm thick Ni—Fe seed layer is deposited by sputtering. This Ni—Fe seed layer exchange-couples to the Ni—Fe third cap layer of the TMR read sensor. An upper shield frame is formed with photolithographic patterning, and an about 1 μm thick Ni—Fe film is then electroplated into the upper shield frame. After removing the photoresist and the Ni—Fe seed layer outside of the upper shield frame, a 4 μm thick Al₂O₃ film is deposited. The read head fabrication process is thus completed.

In one embodiment, after completing the read head fabrication process, a write head fabrication process is conducted. After completing the write head fabrication process, the wafer is cut into rows, and each row is mechanically lapped to attain a stripe of 80 nm in height and to expose an air-bearing surface (ABS) of the read and write heads. A carbon overcoat is deposited on the exposed ABS of the read and write heads. The row is then cut into sliders, and then each slider is connected with a suspension arm for magnetic recording.

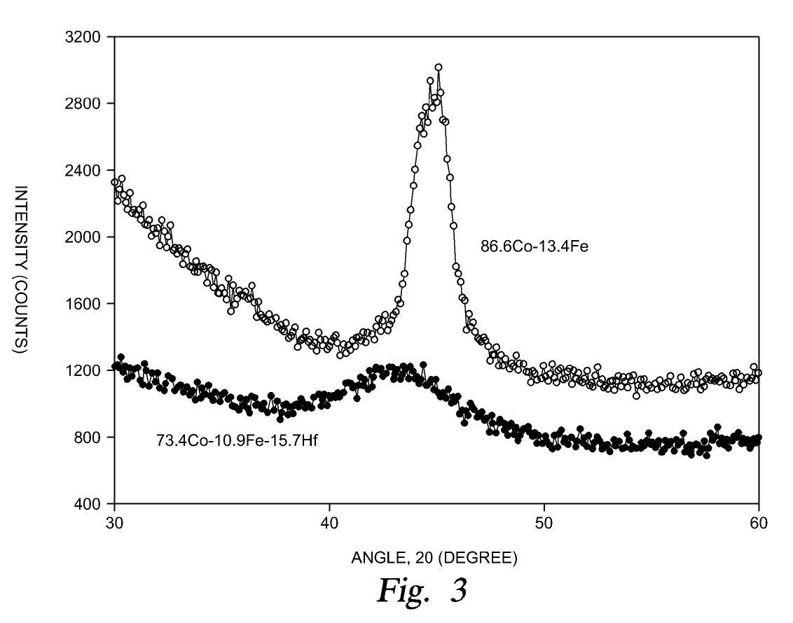

FIG. 3 is a graph depicting x-ray diffraction patterns taken from as-deposited 18.2 nm thick 86.6% Co-13.4% Fe and 22 nm thick 73.4% Co-10.9% Fe-15.7% Hf films, according to one embodiment of the invention. While the Co—Fe film exhibits about 8.0 nm diameter polycrystalline grains with an fcc <111> crystalline structure, the Co—Fe—Hf film exhibits about 1.6 nm diameter nanocrystalline grains indicating a nearly amorphous phase. The Hf incorporation into the Co—Fe film thus causes the formation of the amorphous phase needed for the overlying TMR sensor to grow freely.

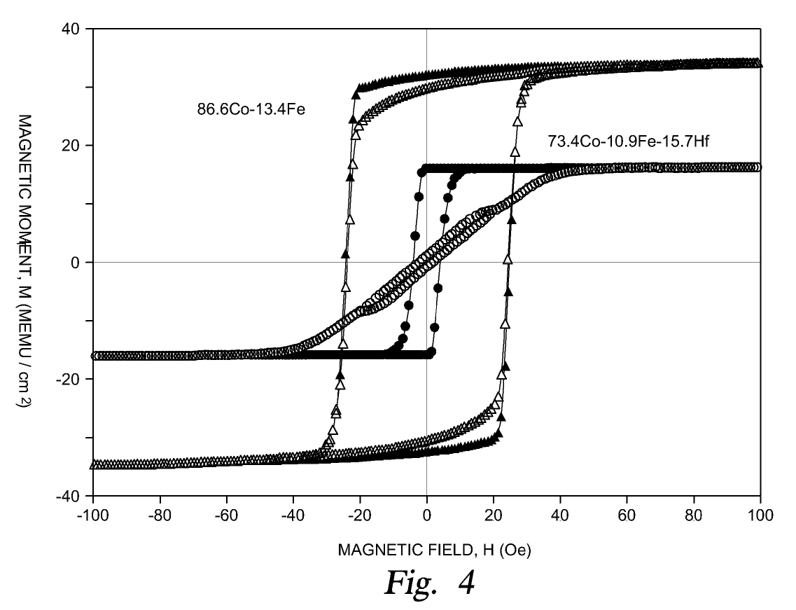

FIG. 4 is a graph depicting easy-axis and hard-axis hysteresis loops of 86.6% Co-13.4% Fe and 73.4% Co-10.9% Fe-15.7% Hf films, which are coated by a 3 nm thick Ta overcoat and annealed for 5 hours at 240° C., according to one embodiment of the invention. A hysteresis loop is formed when the magnetic moment (m) of the Co—Fe or Co—Fe—Hf film varies as function of a magnetic field (H). The easy-axis hysteresis loops are shown in solid symbols and the hard-axis hysteresis loops are shown in open symbols. The Hf incorporation into the Co—Fe film causes a decrease in a saturation magnetization (M_{S}) from 1,415 to 738 memu/cm³, a decrease in an easy-axis coercivity (H_{CE}) from 24.6 to 4.1 Oe, and a conversion from isotropic to anisotropic ferromagnetism. The Co—Fe—Hf film thus exhibits anisotropic soft ferromagnetic properties needed as a part of the lower ferromagnetic shield.

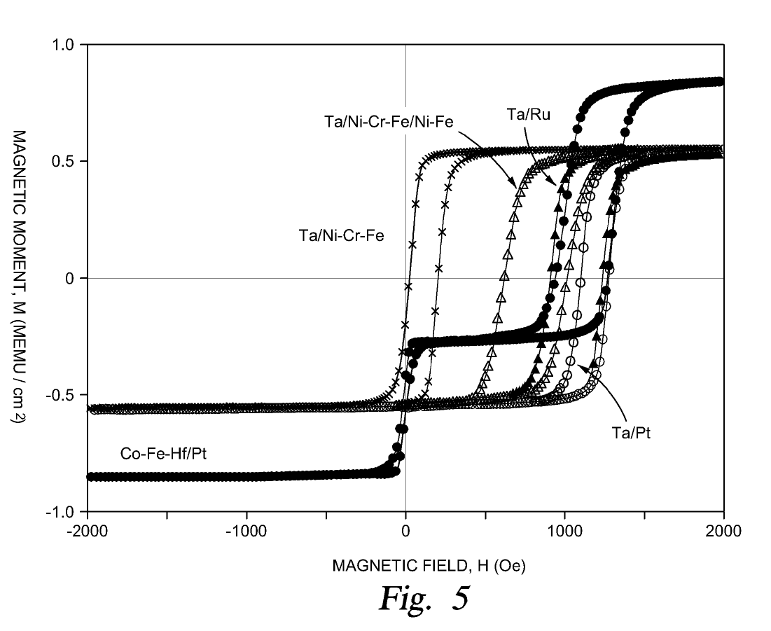

FIG. 5 is a graph depicting easy-axis magnetic responses of Ir—Mn (6 nm)/Co—Fe (3.6 nm) films with various seed layers and a 3 nm thick Ta overcoat after annealing for 5 hours at 240° C., according to one embodiment of the invention. The seed layers comprise Ta (3 nm)/Ni—Cr—Fe (3.2 nm), Ta (3 nm)/Ni—Cr—Fe (3.2 nm)/Ni—Fe (0.8 nm), Ta (3 nm)/Ru (3.2 nm), Ta (3 nm)/Pt (3.1 nm) and Co—Fe—Hf (3 nm)/Pt (3.1 nm). A hysteresis loop is formed when the magnetic moment (m) of the Co—Fe film varies as function of a magnetic field (H). Exchange coupling occurs between the Ir—Mn and Co—Fe films. This coupling increases the easy-axis coercivity (H_{CE}) of the Co—Fe film which is determined by the half width of the hysteresis loop. The exchange coupling also induces an extrinsic unidirectional anisotropy field (H_{UA}) which is determined by the shift of the hystersis loop. Both the H_{CE} and H_{UA} are low when the Ta/Ni—Cr—Fe seed layers with body-centered-cubic (bcc) structures are used. In contrast, both the H_{CE} and H_{UA} are high when a thin Ni—Fe seed layer with an fcc structure induces microstructural reconstruction with the underlying Ni—Cr—Fe seed layer, or when the Ru seed layer with an hcp structure or a Pt seed layer with an fcc structure is used. The seed layers with an fcc and hcp structures exhibit polycrystalline grains with strong fcc <111> and hcp <0001> crystalline textures, respectively, thus facilitating the overlying Ir—Mn pinning layer to epitaxially grow and form polycrystalline grains with an fcc <111> crystalline texture which causes high H_{CE} and H_{UA}. In particular, the Pt seed layer exhibits the largest polycrystalline grains with the strongest fcc <111> crystalline texture, thus facilitating the overlying Ir—Mn pinning layer to epitaxially grow and form the largest polycrystalline grains with the strongest fcc <111> crystalline texture which causes the highest H_{UA}. Both the Pt seed and Ir—Mn pinning layers are preferably sputtered at a target power as high as 600 W for achieving high atomic mobility needed to form a flat surface. In addition, the replacement of the Ta seed layer with the Co—Fe—Hf seed layer causes a negligible decrease in H_{UA}.

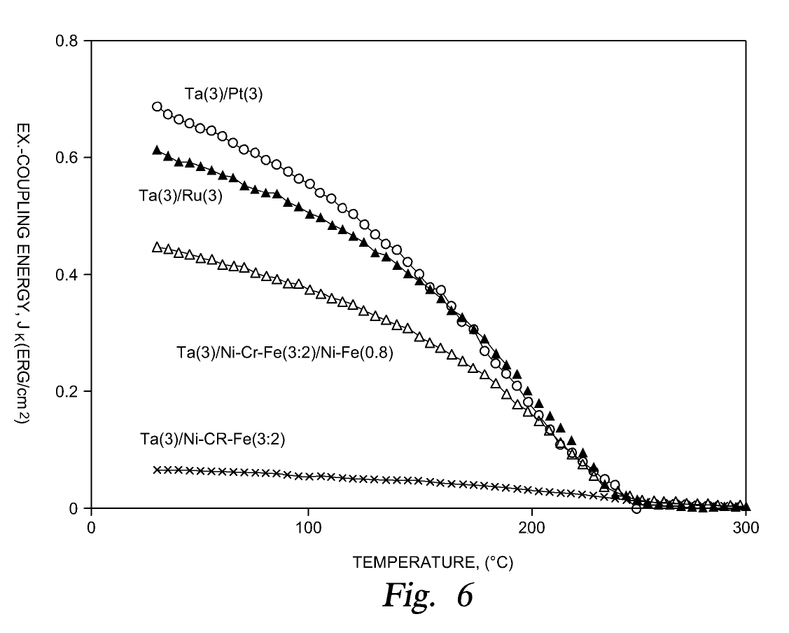

FIG. 6 is a graph depicting the extrinsic interfacial exchange-coupling energy (J_{K}), which is determined by a product of the unidirectional anisotropy field (H_{UA}) and the magnetic moment (m), versus the temperature for the Ir—Mn (6 nm)/Co—Fe (3.6 nm)/Ta (3 nm) films with the corresponding seed layers as described in FIG. 5, according to one embodiment of the invention. The J_{K} decreases with temperature and reaches zero at a blocking temperature (T_{B}). The Ir—Mn/Co—Fe films with the Ta/Pt seed layers exhibit the highest J_{K} at room temperature and a comparable T_{B}.

Table 1 summarizes m, H_{CE}, H_{UA}, J_{K} at room temperature, and T_{B} determined from FIGS. 5 and 6. As can be seen from Table 1, the Ta/Pt seed layers yield a relatively low H_{CE}, the highest H_{UA}, the highest J_{K}, and a comparably high T_{B}. In addition, by replacing the Ta seed layer underneath the Pt seed layer with the Co—Fe—Hf seed layer in accordance with the invention, H_{UA}, J_{K} and T_{B} still remain high enough to ensure robust sensor operation.

| | m | | | | |
|---|---|---|---|---|---|
| Seed Layers | (memu/ | H_{CE} | H_{UA} | J_{K} | T_{B} |
| (nm) | cm²) | (Oe) | (Oe) | (erg/cm²) | (° C.) |
| Ta(3)/Ni—Cr—Fe(3.2) | 0.56 | 88.4 | 119.2 | 0.07 | 250 |
| Ta(3)/Ni—Cr—Fe(3.2)/ | 0.56 | 197.6 | 821.7 | 0.46 | 250 |
| Ni—Fe(0.8) | | | | | |
| Ta(3)/Ru(3.2) | 0.56 | 92.3 | 1099.7 | 0.61 | 250 |
| Ta(3)/Pt(3.1) | 0.58 | 89.0 | 1196.9 | 0.69 | 250 |
| Co—Fe—Hf(3)/Pt(3.1) | 0.28/0.58 | 163.8 | 1116.3 | 0.64 | 250 |

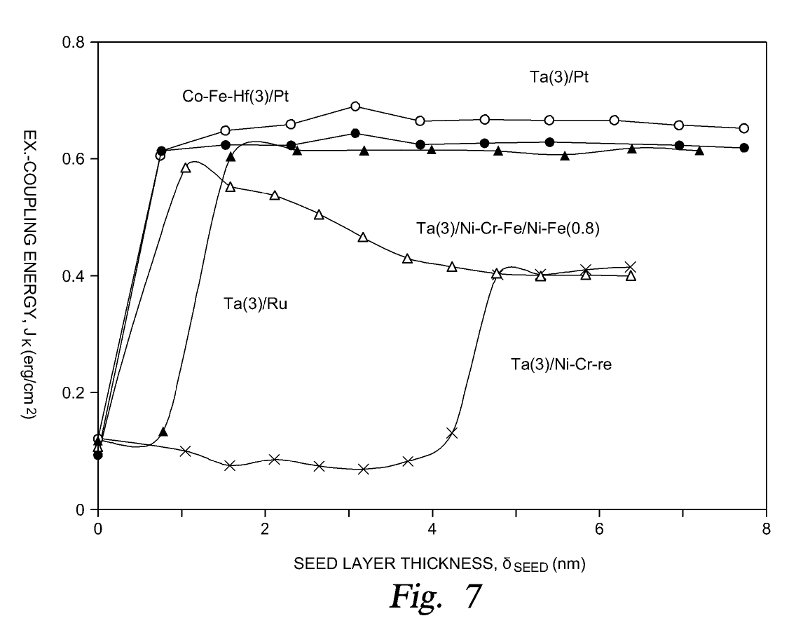

FIG. 7 is a graph depicting J_{K} versus seed-layer thickness (Seed) for Ir—Mn (6 nm)/Co—Fe (3.6 nm) films with various seed layers and a 3 nm thick Ta overcoat after annealing for 5 hours at 240° C., according to one embodiment of the invention. The seed layers comprise Ta (3 nm)/Ni—Cr—Fe, Ta (3 nm)/Ni—Cr—Fe/Ni—Fe (0.8 nm), Ta (3 nm)/Ru Ta (3 nm)/Pt and Co—Fe—Hf (3 nm)/Pt. The Ni—Cr—Fe seed layer requires a thickness of as much as 4.8 nm to form polycrystalline grains large enough to attain a high J_{K}. However, the Ni—Cr—Fe seed layer can be as thin as 1 nm for attaining the high J_{K} when a Ni—Fe seed layer as thin as 0.8 nm is deposited on top of it due to the microstructural reconstruction as previously described. In addition, the Ru and Pt seed layers require thicknesses of 3 and 1 nm, respectively. In one embodiment, since the Pt seed layer requires the smallest thickness, the Pt seed layer may be the most suitable seed layer for the TMR sensor with the smallest read gap.

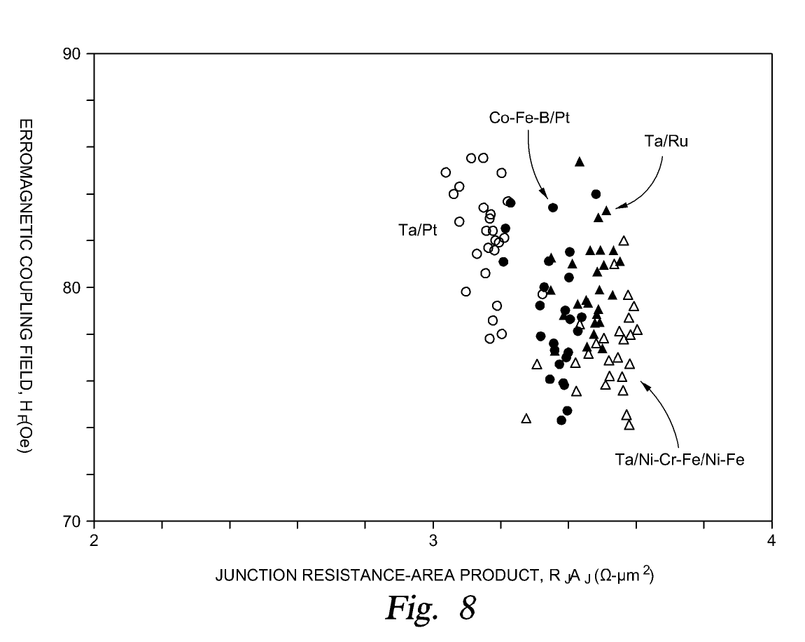

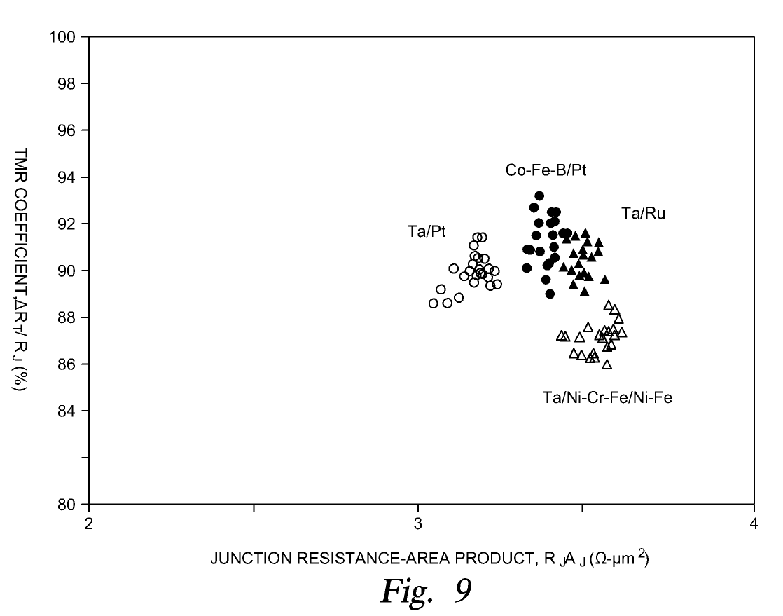

FIGS. 8 and 9 are graphs depicting the ferromagnetic coupling field (H_{F}) and the TMR coefficient (ΔR_{T}/R_{J}), respectively, versus the resistance-area product (R_{J}A_{J}) for the TMR sensors with various seed layers after annealing for 5 hours at 240° C., according to one embodiment of the invention. The seed layers comprise Ta (3 nm)/Ni—Cr—Fe (3.2 nm), Ta (3 nm)/Ni—Cr—Fe (3.2 nm)/Ni—Fe (0.8 nm), Ta (3 nm)/Ru (3.2 nm), Ta (3 nm)/Pt (3.1 nm) and Co—Fe—B (3 nm)/Pt (3.1 nm). It should be noted in this particular example that, instead of the Co—Fe—Hf seed layer, another ferromagnetic amorphous seed layer (specifically, Co—Fe—B) is used, according to an embodiment of the present invention. The use of the Pt seed layer leads to a lower R_{J}A_{J} and a higher ΔR_{T}/R_{J}, while maintaining a comparable H_{F}. These experimental results indicate that the Pt seed layer may facilitate the TMR sensor to exhibit flat interfaces, thereby improving TMR properties.

While the foregoing is directed to embodiments of the invention, other and further embodiments of the invention may be devised without departing from the basic scope thereof, and the scope thereof is determined by the claims that follow.

What is claimed is:

1. A current-perpendicular-to-plane read sensor, comprising:
(a) a lower sensor stack, comprising:
a first seed layer formed by an amorphous ferromagnetic film;
a second seed layer formed by a polycrystalline nonmagnetic film deposited on the first seed layer;
a pinning layer deposited on the second seed layer;
a keeper layer deposited on the pinning layer;
an antiparallel-coupling layer deposited on the keeper layer; and
a reference layer deposited on the antiparallel-coupling layer;
(b) an upper sensor stack; and
(c) an intermediate layer disposed between the lower and upper sensor stacks.

2. The current-perpendicular-to-plane read sensor of claim 1, wherein
the pinning layer comprises an anti-ferromagnetic film comprising iridium (Ir) with a content ranging from 20 to 30 at %, manganese (Mn) with a content ranging from 70 to 80 at %, and chromium (Cr) with a content ranging from 2 to 6 at %, and having a thickness ranging from 4 to 10 nm;
the keeper layer comprises a ferromagnetic film comprising cobalt (Co) with a content ranging from 70 to 80 at %, and iron (Fe) with a content ranging from 20 to 30 at %, and having a thickness ranging from 3 to 5 nm;
the antiparallel-coupling layer is formed by a nonmagnetic film comprising at least one of (Ru), rhodium (Rh), iridium (Ir) and chromium (Cr), and having a thickness ranging from 0.4 to 2 nm;
the reference layer is formed by a ferromagnetic film comprising cobalt (Co) with a content ranging from 40 to 60 at %, iron (Fe) with a content ranging from 30 to 40 at %, and boron (B) with a content ranging from 10 to 30 at %, and having a thickness ranging from 3 to 5 nm;
the first sense layer is formed by a ferromagnetic film comprising cobalt (Co) with a content ranging from 80 to 90 at % and iron (Fe) with a content ranging from 10 to 20 at %, and having a thickness ranging from 0.2 to 0.8 nm; and
the second sense layer is formed by a ferromagnetic film comprising cobalt (Co) with a content ranging from 60 to 80 at %, iron (Fe) with a content ranging from 10 to 20 at %, and boron (B) with a content ranging from 4 to 30 at %, and having a thickness ranging from 2 to 6 nm.

3. The current-perpendicular-to-plane read sensor of claim 1, wherein the intermediate layer is formed by an electrically conducting nonmagnetic copper (Cu) or an oxygen-doped Cu copper (Cu—O) film having a thickness ranging from 1.6 to 4 nm.

4. The current-perpendicular-to-plane read sensor of claim 1, wherein the barrier layer is formed by an electrically insulating nonmagnetic oxygen-doped magnesium (Mg—O) or magnesium oxide (MgO_{X}) film having a thickness ranging from 0.4 to 1 nm.

5. The current-perpendicular-to-plane read sensor of claim 1, wherein the first seed layer comprising cobalt (Co) with a content ranging from 60 to 80 at %, iron (Fe) with a content ranging from 0 to 40 at %, and X with a content ranging from 6 to 30 at %, where X is selected from hafnium (Hf), zirconium (Zr), yttrium (Y) and boron (B), and has a thickness ranging from 1 to 30 nm.

6. The current-perpendicular-to-plane read sensor of claim 1, wherein the second seed layer comprises at least one of:
platinum (Pt) exhibiting a face-centered-cubic (fcc) structure and having a thickness ranging from 1 to 5 nm;
rhodium (Rh) exhibiting a face-centered-cubic (fcc) structure having a thickness ranging from 2 to 6 nm; and
ruthenium (Ru) exhibiting a hexagonal-centered-cubic (hcp) structure having a thickness ranging from 2 to 6 nm.

7. The current-perpendicular-to-plane read sensor of claim 1, wherein the upper sensor stack comprises:
sense layers deposited on the intermediate layer;
a first cap layer formed by a nonmagnetic film deposited on the sense layers;
a second cap layer formed by another nonmagnetic film deposited on the first cap layer; and
a third cap layer formed by a ferromagnetic film deposited on the second cap layer.

8. The current-perpendicular-to-plane read sensor of claim 7, wherein a read gap is defined by a distance between the ferromagnetic first seed layer and the ferromagnetic third cap layer, and has a thickness ranging from 10 to 20 nm.

9. The current-perpendicular-to-plane read sensor of claim 7, wherein the nonmagnetic first cap layer comprises at least one of platinum (Pt), rhodium (Rh) and ruthenium (Ru), and has a thickness ranging from 0.6 to 2 nm.

10. The current-perpendicular-to-plane read sensor of claim 7, wherein the nonmagnetic second cap layer comprises at least one of tantalum (Ta), hafnium (Hf), zirconium (Zr), yttrium (Y), and a thickness ranging from 0.6 to 2 nm.

11. The current-perpendicular-to-plane read sensor of claim 7, wherein the ferromagnetic third cap layer comprises nickel (Ni) with a content ranging from 80 to 90 at % and iron (Fe) with a content ranging from 10 to 20 at %, and a thickness ranging from 10 to 30 nm.

12. A read head, comprising:
a lower ferromagnetic shield;
a current-perpendicular-to-plane (CPP) read sensor, comprising:
(a) a lower sensor stack, comprising:
a first seed layer formed by an amorphous ferromagnetic film deposited on the lower ferromagnetic shield;
a second seed layer formed by a polycrystalline nonmagnetic film deposited on the first seed layer;
(b) an upper sensor stack, comprising:
sense layers formed by ferromagnetic films;
cap layers formed by nonmagnetic and ferromagnetic films;
(c) an intermediate layer disposed between the lower and upper sensor stacks; and
an upper ferromagnetic shield deposited on the cap layer.

13. The read head of claim 12, wherein the CPP read sensor further comprises:
a pinning layer deposited on the second seed layer;
a keeper layer deposited on the pinning layer;
an antiparallel-coupling layer deposited on the keeper layer; and
a reference layer deposited on the antiparallel-coupling layer.

14. The read head of claim 12, wherein the second seed layer comprises platinum (Pt).

15. A hard disk drive, comprising:
a hard disk;
an actuator arm;
a slider disposed upon a distal end of the actual arm and positionable over the hard disk;
a read head disposed on the slider, the read head comprising:
a lower ferromagnetic shield;
a current-perpendicular-to-plane read sensor, comprising:
(a) a lower sensor stack, comprising:
a first seed layer formed by an amorphous ferromagnetic film deposited on the lower ferromagnetic shield;
a second seed layer formed by polycrystalline nonmagnetic film deposited on the first seed layer;
a pinning layer deposited on the second seed layer;
a keeper layer deposited on the pinning layer;
an antiparallel-coupling layer deposited on the keeper layer; and
a reference layer deposited on the antiparallel-coupling layer;
(b) an upper sensor stack, comprising:
sense layers formed by ferromagnetic films; and
cap layers formed by nonmagnetic and ferromagnetic films; and
(c) an intermediate layer disposed between the lower and upper sensor stacks;
an upper ferromagnetic shield; and
a write head fabricated on the read head.

16. The hard disk drive of claim 15, wherein the second seed layer comprises platinum (Pt).

17. A method for fabricating a current-perpendicular-to-plane read sensor, the method comprising:
depositing a first seed layer formed by an amorphous ferromagnetic film on a lower shield;
depositing a second seed layer formed by a polycrystalline nonmagnetic film on the first seed layer;
depositing a pinning layer on the second seed layer;
depositing a keeper layer on the pinning layer;
depositing an antiparallel-coupling layer on the keeper layer;
depositing a reference layer on the antiparallel-coupling layer;
depositing an intermediate layer on the reference layer;
depositing sense layers on the intermediate layer; and
depositing a capping structure on the sense layers.

18. The method of claim 17, wherein depositing a capping structure comprises:
depositing a first cap layer formed by a first nonmagnetic film on the sense layers;
depositing a second cap layer formed by a second nonmagnetic film on the first cap layer; and
depositing a third cap layer formed by a ferromagnetic film on the second cap layer.

19. The method of claim 17, wherein the intermediate layer is formed by an electrically conducting nonmagnetic copper (Cu) or an oxygen-doped Cu copper (Cu—O) film having a thickness ranging from 1.6 to 4 nm.

20. The method of claim 17, wherein the barrier layer is formed by an electrically insulating nonmagnetic oxygen-doped magnesium (Mg—O) or magnesium oxide (MgO_{X}) film having a thickness ranging from 0.4 to 1 nm.

21. The method of claim 17, wherein the first seed layer comprises cobalt (Co) with a content ranging from 60 to 80 at %, iron (Fe) with a content ranging from 0 to 40 at %, and X with a content ranging from 6 to 30 at %, where X is selected from hafnium (Hf), zirconium (Zr), yttrium (Y) and boron (B), and has a thickness ranging from 1 to 30 nm.

22. The method of claim 17, wherein the second seed layer contains at least one of:
platinum (Pt) exhibiting a face-centered-cubic (fcc) structure and having a thickness ranging from 1 to 5 nm;
rhodium (Rh) exhibiting a face-centered-cubic (fcc) structure having a thickness ranging from 2 to 6 nm; and
ruthenium (Ru) exhibiting a hexagonal-centered-cubic (hcp) structure having a thickness ranging from 2 to 6 nm.

23. The method of claim 17, wherein a read gap is defined by a distance between the ferromagnetic first seed layer and the ferromagnetic third cap layer, and has a thickness ranging from 10 to 20 nm.

24. An article of manufacture, comprising:
a first seed layer formed by an amorphous ferromagnetic film;
a second seed layer formed by a polycrystalline nonmagnetic film;
a first cap layer formed by a nonmagnetic film;
a second cap layer formed by another nonmagnetic film; and
a third cap layer formed by a ferromagnetic film; wherein the first seed layer, the second seed layer, the first cap layer, the second cap layer, and the third cap layer are components of a current-perpendicular-to-plane read sensor; wherein a read gap is defined by a distance between the ferromagnetic first seed layer and the ferromagnetic third cap layer.
